(19) United States
(12) Patent Application Publication
(10) Pub. No.: US 2022/0250881 A1
(43) Pub. Date: Aug. 11, 2022

(54) TOY RETRIEVAL APPARATUS

(71) Applicant: Darren Alexander Ortwein, Kamloops (CA)

(72) Inventor: Darren Alexander Ortwein, Kamloops (CA)

(21) Appl. No.: 17/172,149

(22) Filed: Feb. 10, 2021

(51) Int. Cl. B66D 1/28; F16B 47/00; B65H 75/48; B66D 1/02; B60R 7/04

(52) U.S. Cl. CPC B66D 1/28; F16B 47/00; B66D 2700/0183; B66D 1/02; B60R 7/04; B65H 75/486

(57) ABSTRACT

A toy retrieval apparatus wherein the present invention is configured to facilitate retrieval of a fallen toy or similar object subsequent a child sitting in the rear seat of a vehicle dropping the toy and a passenger in the front seat can utilize the present invention to retrieve the toy. The toy retrieval apparatus includes a housing wherein the housing has a spring loaded winding member disposed in the interior volume thereof. The spring loaded winding member has a cord member secured thereto. The cord member has attached to the distal end an attachment member. The attachment member of the present invention is formed to releasably secure to a toy through either adherence to the outer cover of the attachment member or being secured with finger members of the attachment member. The attachment member includes a malleable metal structural insert member that provides bending of the finger members.

### FIELD OF THE INVENTION

The present invention relates generally to retrieval devices, more specifically but not by way of limitation, an apparatus that is configured to be releasably secured to an object such as but not limited to a child's toy wherein the apparatus includes a retraction member that is operable to return the toy proximate the child if dropped by the child.

### BACKGROUND

Millions of people travel with young children in their vehicles on a daily basis. Whether commuting to school or traveling to other destinations these young children are most often required by law to ride in the rear seat of the vehicle and some are even required to be placed in car seats. Most often caretakers or parents will provide the child with a toy or similar object to engage with during their time in the car. These objects can include but are not limited to various games or stuffed animals.

A problem occurs when the child drops the toy and the toy has been dropped wherein the toy lands on the floorboard or some other place that is out of reach for the child. Many times the child will become upset once losing the toy and this can be distracting for the driver. Often the driver cannot reach the toy while driving the car and if an attempt is made to reach the toy while driving this can create a dangerous situation. Additionally, it may not either be desirable or possible to pull the vehicle over so that the driver or other passenger in the front seat of the vehicle can reach the toy and return to the child.

Accordingly, there is a need for an apparatus that is configured to releasably secure to a toy or similar object that includes a housing having a retraction member wherein the retraction member includes an end configured to be releasably secured to a toy or similar object and the apparatus functions to assist in returning the toy or similar object to a child.

### SUMMARY OF THE INVENTION

It is the object of the present invention to provide a toy retrieval apparatus configured to be disposed within a vehicle and have a portion thereof releasably secured to a toy or similar object wherein the present invention includes a housing.

Another object of the present invention is to provide an apparatus operable to assist a driver or front seat passenger retrieve a fallen toy in the rear seat of the same vehicle wherein the housing is configured to be releasably secured to an object within reach of the front seat passengers/driver of the vehicle.

A further object of the present invention is to provide a toy retrieval apparatus configured to be disposed within a vehicle and have a portion thereof releasably secured to a toy or similar object wherein the housing has operably coupled therein a retraction member wherein the retraction member includes a winding member and a cord member.

Still another object of the present invention is to provide an apparatus operable to assist a driver or front seat passenger retrieve a fallen toy in the rear seat of the same vehicle wherein the cord member has an attachment member on the distal end thereof wherein the attachment member is configured to be releasably secured to a toy or similar small object.

An additional object of the present invention is to provide a toy retrieval apparatus configured to be disposed within a vehicle and have a portion thereof releasably secured to a toy or similar object wherein the attachment member includes an outer surface operable to releasably secure to a toy or small object.

Yet a further object of the present invention is to provide an apparatus operable to assist a driver or front seat passenger retrieve a fallen toy in the rear seat of the same vehicle wherein the attachment member includes a malleable structural member so as to facilitate an additional technique to releasably secure to a toy or small object.

Another object of the present invention is to provide a toy retrieval apparatus configured to be disposed within a vehicle and have a portion thereof releasably secured to a toy or similar object wherein the cord member is manufactured so as to be tangle free.

An alternate object of the present invention is to provide an apparatus operable to assist a driver or front seat passenger retrieve a fallen toy in the rear seat of the same vehicle wherein the winding member could be either manual or power operated.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an exemplary embodiment of the present invention; and

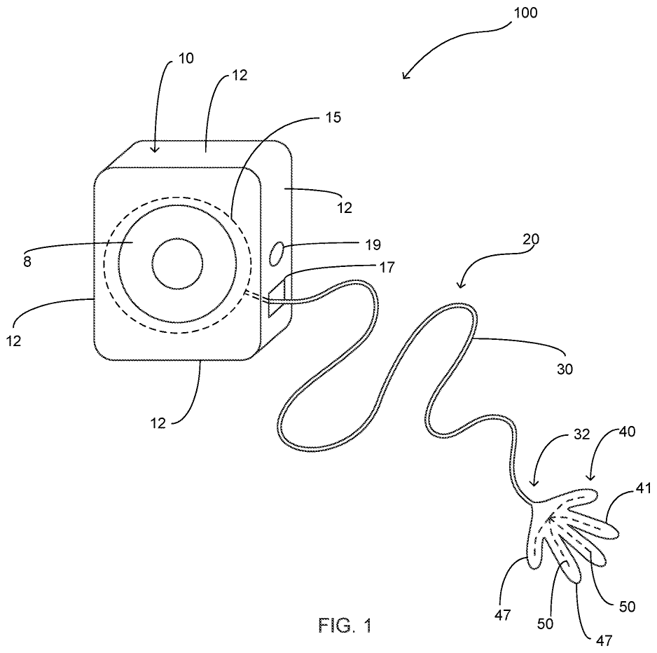

FIG. 2 is a perspective view of the present invention installed within a vehicle.

### DETAILED DESCRIPTION

Referring now to the drawings submitted herewith, wherein various elements depicted therein are not necessarily drawn to scale and wherein through the views and figures like elements are referenced with identical reference numerals, there is illustrated a toy retrieval apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

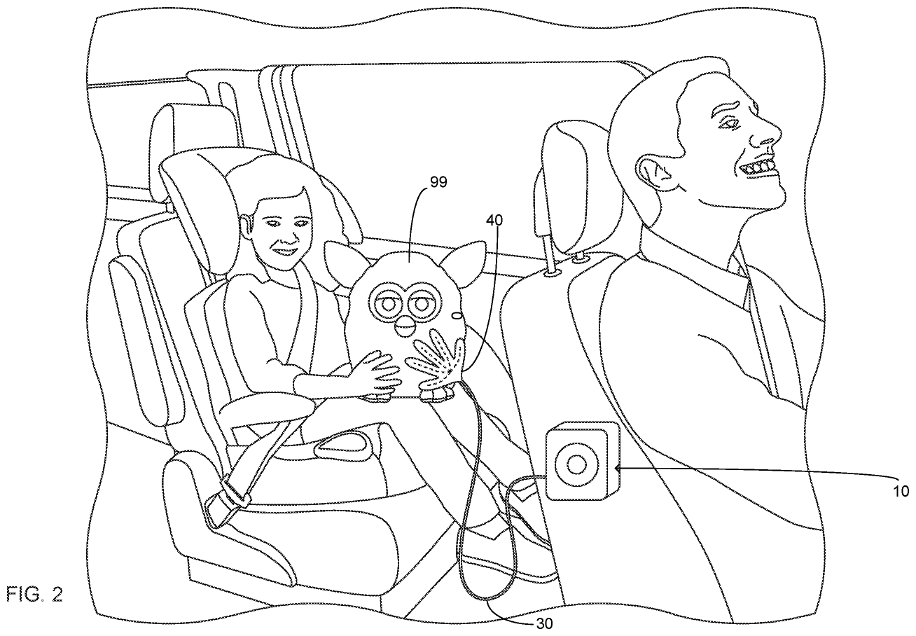

Referring to the Figures herein, the toy retrieval apparatus 100 includes a housing 10. The housing 10 is manufactured from a durable material such as but not limited to plastic. The housing 10 includes a plurality of walls 12 integrally formed to create an interior volume. The housing 10 as will be further discussed herein is configured to house a portion of the retraction member 20 within the interior volume thereof. The housing 10 is manufactured of suitable size so as to have an interior volume that can accommodate substantially all of the winding member 25 therein. While the housing 10 is illustrated herein being a particular shape, it should be understood within the scope of the present invention that the housing 10 could be formed in alternate shapes and sizes. Furthermore, it is contemplated within the scope of the present invention that the housing 10 could be shaped like an animal or other object for decorative purposes. The housing 10 includes suction cup member 8 secured to the exterior thereof. The suction cup member 8 is provided as one technique to secure the housing 10 to a surface such as but not limited to a glass window. It should be understood within the scope of the present invention that the housing 10 could use additional elements to secure to other areas within a vehicle such as but not limited to a seat as shown herein in FIG. 2.

Disposed within the interior volume of the housing 10 is the winding member 25. The winding member 25 is a drum shaped wheel that is biasly mounted utilizing a spring or similar element wherein the winding member 25 is configured to facilitate winding of the cord member 30. The winding member 25 is operably coupled to the cord member 30 and functions to provide deployment and retraction thereof. The cord member 30 includes a portion thereof that maintains engagement with the winding member 25. The cord member 30 in a preferred embodiment is a flat tangle free cord manufactured from silicon or similar material. It should be understood within the scope of the present invention that the cord member 30 could be manufactured in various lengths. The cord member 30 is journaled through the aperture 17 in the housing 10 so as to be operably coupled to the winding member 25. Button 19 is present on the housing 10 and is operably coupled to the winding member 25 so as to provide engagement thereof wherein ensuing depression of the button 19 the winding member 25 retrieves any portion of cord member 30 that is located exterior of the housing 10. The aforementioned assist in retrieval of an exemplary toy 99 as will be further discussed herein. It is contemplated within the scope of the present invention that the winding member 25 could be manually operated or power driven through a suitable battery operated electric motor.

Secured to the second end 32 of the cord member 30 is the attachment member 40. The attachment member 40 is configured to be releasably secured to the exemplary toy 99 while the child is engaged therewith. The attachment member 40 includes an outer covering 41 wherein the outer covering 41 has disposed thereon a material that is operable to releasably secure to a desired exemplary toy 99. It is contemplated within the scope of the present invention that the outer covering 41 could have a pressure sensitive adhesive disposed thereon. It is additionally contemplated within the scope of the present invention that the outer covering 41 could be manufactured from a hook and loop material so as to secure to an exemplary toy 99. While two exemplary embodiments of the outer covering 41 have been discussed, it should be understood within the scope of the present invention that alternate materials could be utilized to provide the desired functionality of releasably securing the attachment member 40 to an exemplary toy 99.

Disposed within the attachment member 40 are structural members 50. The structural members 50 are manufactured from a malleable metal so as to facilitate the bending thereof and as such the finger members 47 of the attachment member 40. The structural members 50 provide a second technique to secure the attachment member 40 to an exemplary toy 99 by facilitating the bending of a finger member 47 so as to at least partially surround a section of an exemplary toy 99 providing engagement thereof. It should be understood within the scope of the present invention that the structural member 50 could be manufactured from various suitable malleable metals. Furthermore, it should be understood within the scope of the present invention that the attachment member 40 could have various quantities of finger members 47 but it is contemplated that the attachment member 40 has at least two finger members 47.

As is illustrated herein in FIG. 2, the toy retrieval apparatus 100 has been mounted utilizing an alternate technique than the suction cup member 8 to a seat within a passenger compartment of a vehicle. The attachment member 40 has been releasably secured to the exemplary toy 99. In the event the exemplary toy 99 is dropped by the child, the driver can engage the button 19 so as to activate the winding member 25 in order to retrieve the cord member 30. This allows the driver to more easily grab the fallen exemplary toy 99 without leaving their seated position in the front seat and then return the exemplary toy 99 to the child.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A toy retrieval apparatus configured to be operably coupled to a toy or similar object wherein the toy retrieval apparatus functions to assist in recovery of the toy upon falling to an area unreachable wherein the toy retrieval apparatus comprises:
a housing, said housing having a plurality of walls, said plurality of walls being integrally formed to create an interior volume, said plurality of walls being manufactured from a rigid material;
a winding member, said winding member being disposed within said interior volume of said housing, said winding member operable to rotate in a clockwise and a counterclockwise direction;
a cord member, said cord member being operably coupled to said winding member, said cord member having a portion extending beyond said housing, said cord member having a first end and a second end; and
an attachment member, said attachment member being secured to said second end of said cord member, said attachment member having an outer covering, said attachment member being configured to be releasably secured to the toy or similar object.

2. The toy retrieval apparatus as recited in claim 1, wherein said attachment member further includes a structural member disposed within an interior thereof, said structural member being manufactured from a malleable metal so as to facilitate bending of a portion of the attachment member in order to releasably secure the attachment member to a toy or similar object.

3. The toy retrieval apparatus as recited in claim 2, wherein the housing further includes an aperture, said aperture in said housing configured to have a portion of the cord member journaled therethrough so as to couple to said winding member.

4. The toy retrieval apparatus as recited in claim 3, wherein said winding member is spring loaded so as to facilitate retrieval of said cord member.

5. The toy retrieval apparatus as recited in claim 4, wherein the winding member further includes an operational button coupled thereto and accessible on a side of the housing.

6. The toy retrieval apparatus as recited in claim 5, wherein the outer covering of the attachment member includes a material disposed thereon operable to releasably secure to the toy or similar object.

7. The toy retrieval apparatus as recited in claim 6, wherein the outer covering includes a pressure sensitive adhesive.

8. The toy retrieval apparatus as recited in claim 6, wherein the outer covering is formed from a hook and loop material.

9. A toy retrieval apparatus configured to be operably coupled to a toy to assist in recovery of the toy upon falling to an area in a vehicle unreachable wherein the toy retrieval apparatus comprises:
a housing, said housing having a plurality of walls, said plurality of walls being integrally formed to create an interior volume, said plurality of walls being manufactured from a rigid material, said housing having an aperture formed in one of said plurality of walls;
a winding member, said winding member being disposed within said interior volume of said housing, said winding member being a biasly mounted drum wherein the winding member is operable to rotate in one direction upon being engaged by an operational button;
a cord member, said cord member having a portion operably coupled to said winding member, said cord member having a portion extending beyond said housing, said cord member having a first end and a second end; and
an attachment member, said attachment member being secured to said second end of said cord member, said attachment member having a plurality of finger members, said attachment member having an outer covering, said attachment member being configured to be releasably secured to the toy or similar object.

10. The toy retrieval apparatus as recited in claim 9, and further including a structural member, said structural member being disposed within an interior of said attachment member and the plurality of finger members thereof, said structural member being manufactured from a malleable metal, said structural member operable to facilitate bending of the plurality of finger members so as to maintain an alternate shape thereof in order to grasp the toy.

11. The toy retrieval apparatus as recited in claim 10, wherein the outer covering of the attachment member includes a material disposed thereon operable to releasably secure to the toy.

12. The toy retrieval apparatus as recited in claim 11, wherein the outer covering is formed from a hook and loop material.

13. The toy retrieval apparatus as recited in claim 11, wherein the outer covering includes a pressure sensitive adhesive.

14. The toy retrieval apparatus as recited in claim 11, wherein the housing further includes a suction cup member secured to one of said plurality of walls.
